(19) United States
(12) Patent Application Publication
(10) Pub. No.: US 2008/0036321 A1
(43) Pub. Date: Feb. 14, 2008

(54) MAGNETIC FLOATING SHAFT SET AND APPARATUS USING SAME

(76) Inventor: Chien-Chun Yu, Taipei County (TW)

Correspondence Address: PAI PATENT & TRADEMARK LAW FIRM, 1001 FOURTH AVENUE, SUITE 3200, SEATTLE, WA, 98154, US

(21) Appl. No.: 11/621,716

(22) Filed: Jan. 10, 2007

(30) Foreign Application Priority Data
Aug. 11, 2006 (TW) 95214228
Nov. 16, 2006 (TW) 95220206

(51) Int. Cl. H02K 7/09; F04B 17/00

(52) U.S. Cl. 310/90.5; 417/423.12; 310/90

(57) ABSTRACT

A magnetic floating shaft set is disclosed to include two guides kept apart from each other at a distance in such a manner that one guide is movable relative to the other guide to adjust the distance between the two guides, a shaft set in between the two guides with the two distal ends thereof respectively facing the two guides, a magnetic member mounted on the shaft, and a winding coaxially mounted around the shaft for generating a magnetic field to induce the magnetic member and to further cause floating of the shaft between the two guides and rotation of the magnetic member on the shaft.

### BACKGROUND OF THE INVENTION

1. Field of the Invention The present invention relates to magnetic floating shafts and more particularly to a magnetic floating shaft set for high speed rotation.

2. Description of the Related Art

Cooling fan is intensively used in different fields to cause currents of air for cooling or dissipation of heat. FIG. 16 shows a conventional cooling fan 1. As illustrated, the cooling fan 1 comprises a stator 2 and a rotor 3. The stator 2 comprises an axle bearing 4, a winding 5 arranged around the axle bearing 4. The rotor 3 has a shaft 6, a magnetic ring 7, and a plurality of blades 8. The shaft 6 is inserted through the axle bearing 4. The blades 8 are radially connected to the shaft 6. During operation of the cooling fan 1, the interaction between the magnetic ring 7 and the winding 5, causes the shaft 6 to rotate. During rotation of the shaft 6, the blades 8 are moved with the shaft 6 to cause currents of air.

During operation of the aforesaid cooling fan 1, the direction of the magnetic force produced by the winding 5 and the magnet ring 7 is not in conformity with the extending direction of the shaft 6, thereby producing a biasing angle 9. Further, the axle bearing 4 starts to wear after a long use of the cooling fan 1, causing the biasing angle 9 to increase. With the wearing of the axle bearing 4, the mechanical performance of the axle bearing 4 is relatively lowered, thereby shortening the working life and performance of the cooling fan 1. Further, because the axle bearing 4 is an open structure that cannot eliminate accumulation of dust. Accumulation of dust affects the functioning of the axle bearing 4, thereby increasing the noise and lowering the mechanical performance.

U.S. Pat. No. 6,309,190 discloses a design entitled “Shaft supporting structure for an axial fan”. According to this design, the shaft supporting structure for an axial fan includes a base and a casing. Electronic control elements are provided for driving the fan wheel under by virtue of the induction of a coil. The fan wheel includes blades and a magnet ring that can be inducted for driving a central shaft thereof. The central shaft includes two ends that are respectively supported in an arcuate recess of a support member in the base and an arcuate recess of another support member in the casing.

The aforesaid shaft supporting structure uses a support member in the base and an arcuate recess of another support member in the casing to support the central shaft, instead of axle bearings used in conventional designs. However, the magnetic force induced between the coil and the magnetic ring causes the axial fan to bias sideways while driving the fan wheel. Further, rotation of the fan not only causes currents of air but also causes a reaction force against the fan. If the distance between the two support members is shorter than the length of the central shaft due to a manufacturing error, the support members can still support rotation of the central shaft with the fan wheel. However, under the action of the magnetic force and the reaction force, a heavy contact force and reaction force may be produced between one end of the central shaft and the associating support member, resulting in abnormal wearing or deformation of the central shaft. When the central shaft starts to wear or to deform, the fan cannot be rotated at a high speed, and a high noise will be produced during rotation of the fan, thereby shortening the working life of the fan.

### SUMMARY OF THE INVENTION

The present invention has been accomplished under the circumstances in view. It is one object of the present invention to provide a magnetic floating shaft set and an apparatus using the magnetic floating shaft set that is suitable for high speed operation.

It is another object of the present invention to provide a magnetic floating shaft set and an apparatus using the magnetic floating shaft set that have the characteristics of optimal mechanical efficiency, long working life, and low noise level.

To achieve these and other objects of the present invention, the magnetic floating shaft set comprises two guides kept apart from each other at a distance, one of the two guides being movable relative to the other to change the distance between the two guides; a shaft set in between the two guides, the shaft having two distal ends respectively facing the two guides; a magnetic member mounted on the shaft; and a winding coaxially mounted around the shaft and adapted to generate a magnetic field to induce the magnetic member and to further cause floating of the shaft between the two guides and rotation of the magnetic member with the shaft. With the aforesaid arrangement, the magnetic floating shaft set and the apparatus using the magnetic floating shaft set possess a simple structure. Further, the small contact area between the shaft and the guides greatly reduces the friction area, thereby improving the mechanical performance, prolonging the working life of the cooling fan and reducing noise level. Further, the invention allows adjustment of the distance between the two guides, allowing smooth rotation of the magnetic floating shaft set for high speed operation.

### BRIEF DESCRIPTION OF THE DRAWINGS

FIG. 1 is an elevational assembly view of a first embodiment of the present invention.

FIG. 2 is a sectional plain view in an enlarged scale of the first embodiment of the present invention.

FIG. 3 is a schematic drawing of a part of the first embodiment of the present invention, showing a displacement status of the shaft.

FIG. 4 is schematic drawing of a part of the first embodiment of the present invention, showing the relative action between the winding and the magnetic member.

FIG. 5 is a schematic drawing of a part of the first embodiment of the present invention, showing the relation between the shaft and the guides.

FIG. 6 is a schematic drawing showing the relative action between the shaft and the guides during operation of the cooling fan according to the first embodiment of the present invention.

FIG. 7 is a schematic drawing of a part of the first embodiment of the present invention, showing movement of the first guide relative to the second guide.

FIG. 8 is similar to FIG. 2, but showing a magnetic floating bearing set between the shaft and the winding.

FIG. 9 is a sectional view of a second embodiment of the present invention.

FIG. 10 is a sectional view of a third embodiment of the present invention.

FIG. 11 is a sectional view of a fourth embodiment of the present invention.

FIG. 12 is similar to FIG. 11, but showing a ball set in the end of the shaft.

FIG. 13 is a sectional view of a fifth embodiment of the present invention.

FIG. 14 is a sectional view of a sixth embodiment of the present invention.

FIG. 15 is similar to FIG. 14, but showing bearings set between the shaft and one of the guides.

FIG. 16 is a schematic drawing showing the structure of a prior art cooling fan.

### DETAILED DESCRIPTION OF THE INVENTION

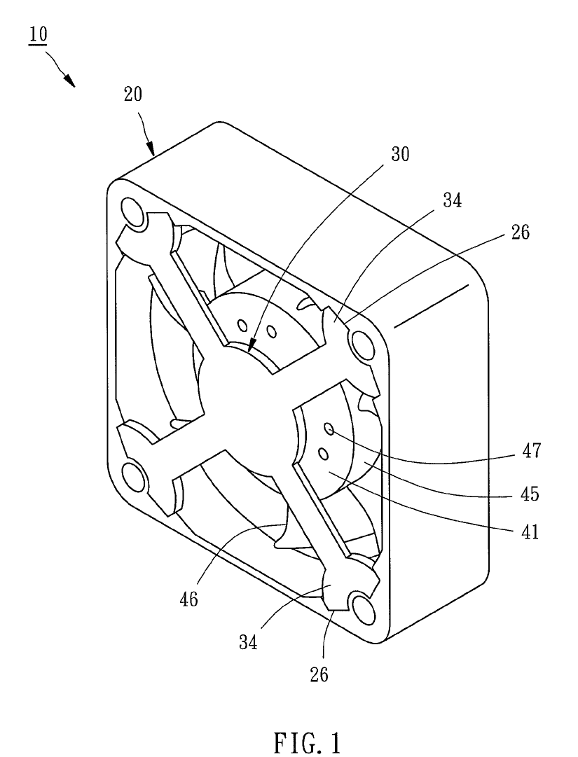

Referring to FIGS. 1˜3, a magnetic floating shaft set 50 in accordance with a first embodiment of the present invention is shown used in a cooling fan 10. The cooling fan 10 comprises a first rack 20 and a second rack 30. The magnetic floating shaft set 50 is mounted in between the first rack 20 and the second rack 30.

The first rack 20 has four limit portions 26 at one side. The limit portions 26 are respectively formed in the corners of the rack 20. The second rack 30 has four locating portions 34. The locating portions 34 are respectively engaged into the limit portions 26 to secure the second rack 30 to the first rack 20.

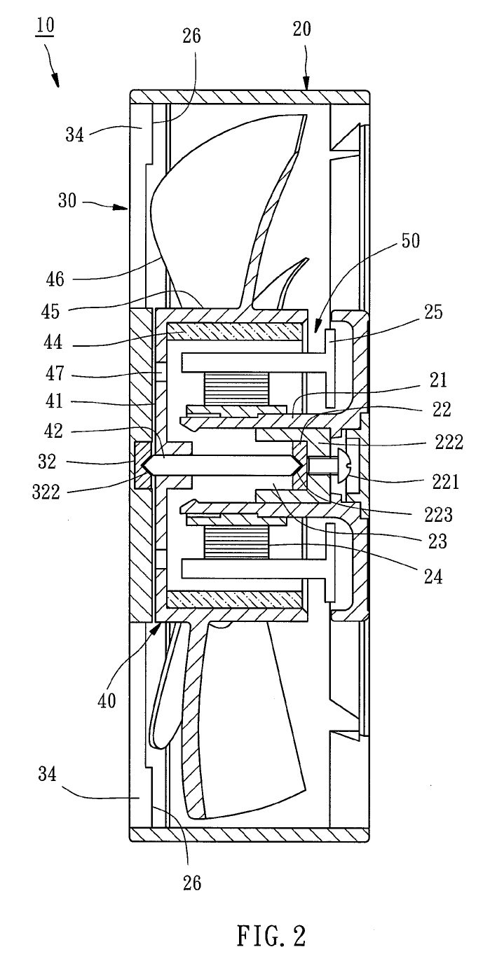

As illustrated in FIG. 2, the first rack 20 has a hollow center portion 21 that accommodates a positioning member 222. The positioning member 222 has an insertion hole 23. The positioning member 222 is mounted with an adjustment member 221. According to this embodiment, the adjustment member 221 is a screw. The adjustment member 221 is screwed into the positioning member 222 and threaded into the insertion hole 23.

The magnetic floating shaft set 50 comprises a first guide 22, a second guide 32, a shaft 42, an actuator 40, a magnetic member 44, and a winding 24.

The first guide 22 and the second guide 32 are respectively formed of a wear resistant material, for example, diamond, graphite or ceramics, each having a groove 223 or 322. The first guide 22 is placed in the insertion hole 23 of the positioning member 222 and joined with the adjustment member 221. The second guide 32 is mounted in the second rack 30 corresponding to the first guide 22 so that the grooves 223 and 322 of the guides 22 and 32 are respectively disposed in the first rack 20 and the second rack 30 and facing each other. When the adjustment member 221 in the first rack 20 is rotated relative to the positioning member 222, the first guide 22 is moved by the adjustment member 221 in the insertion hole 23 of the positioning member 222 to adjust the distance between the first guide 22 and the second guide 32.

The shaft 42 is set between the first guide 22 and the second guide 32, having its two ends respectively facing the grooves 223 and 322 of the guides 22 and 32.

The actuator 40 has a circular base 41. The circular base 41 has a plurality of through holes 47 for heat dissipation, and a sidewall 45 extending around the border thereof. The shaft 42 is perpendicularly mounted in the center of the circular base 41, having its one end extending out of the circular base 41 and its other end extending to the inside of the sidewall 45. Blades 46 are radially affixed to the outer side of the sidewall 45.

The magnetic member 44 is a magnetic ring mounted around the inner side of the sidewall 45 for synchronous movement with the actuator 40 and the shaft 42.

The winding 24 has an annular circuit board 25. The winding 24 and the annular circular board 25 are mounted in the center portion 21 of the first rack 20 in such a manner that the winding 24 is coaxially disposed around the shaft 42 between the magnetic member 44 and the shaft 42. The centerline of the magnetic field of the magnetic member 44 is in alignment with the centerline of the magnetic field produced by the winding 24.

Because of the interaction between the magnetic field of the magnetic member 44 and the magnetic filed produced by the winding 24 and the centerline of the magnetic field of the magnetic member 44 is in alignment with the centerline of the magnetic field produced by the winding 24, the actuator 40 is in a magnetic floating status and the two ends of the shaft 42 do not touch the first guide 22 and the second guide 32. During operation of the cooling fan 10, the winding 24 is energized to induce with the magnetic member 44 an electric potential, thereby an angular displacement of the magnetic member 44, and therefore the actuator 40 is rotated. During rotation of the actuator 40, the blades 46 are rotated with the actuator 40 to cause currents of air for cooling or heat dissipation.

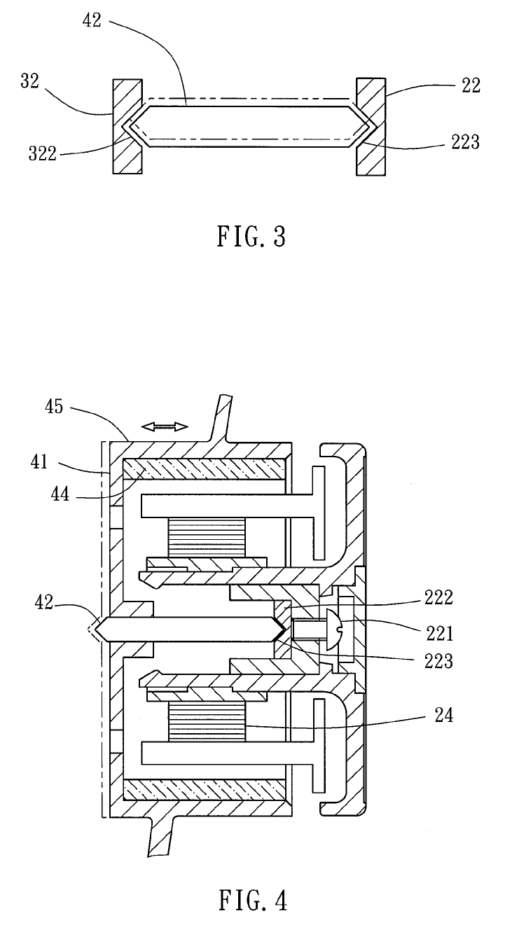

As shown in FIG. 3, if the shaft 42 is biased at the start during operation due to magnetic force or other factors, the grooves 223 and 322 of the guides 22 and 32 will guide and limit the movement of the shaft 42, keeping the motion of the shaft 42 straight, and therefore the shaft 42 is rotating steadily.

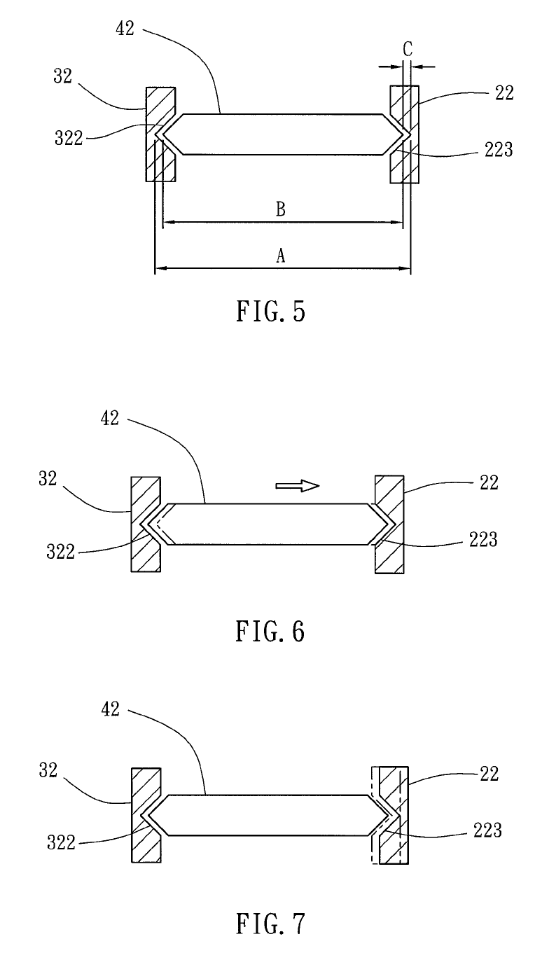

Referring to FIGS. 4˜7, during rotation of the actuator 40, the reaction force produced upon moving of the blades 46 against air forces the actuator 40 to move linearly along the axis of the shaft 42. Let the length of the shaft 42 be denoted by B, the linear moving distance of the shaft 42 during its rotation by C, and the maximum distance between the grooves 223 and 322 of the guides 22 and 32 by A. Thus, A>B+C (see FIG. 5). Thus, the shaft 42 is moving between the guides 22 and 32 during operation of the cooling fan 10 without causing unnecessary active force or reaction force. If the shaft 42 is tightly stopped against the first guide 22 or the second guide 32 or caused to wear or to deform during a test procedure in the factory, or if the gap between the shaft 42 and the guide 22 or 32 is excessively large, as shown in FIG. 7, the user can operate the adjustment member 221 to move the first guide 22 to adjust the gap between the shaft 42 and the guide 22 or 32 and changing the contact area between the shaft 42 and the guides 22 and 32 to assure smooth rotation of the actuator 40 and to prevent stoppage of the shaft 42 against the guide 23 or 32, and therefore the rotating speed of the actuator 40 of the cooling fan 10 can be accelerated.

As stated above, the magnetic floating shaft set 50 and the apparatus using same of the invention possess a simple structure. Further, the small contact area between the shaft 42 and the guides 22 and 32 greatly reduces the friction area, thereby improving the mechanical performance, prolonging the working life of the cooling fan and reducing noise level. Further, the invention allows adjustment of the distance between the two guides, allowing smooth rotation of the magnetic floating shaft set for high speed application.

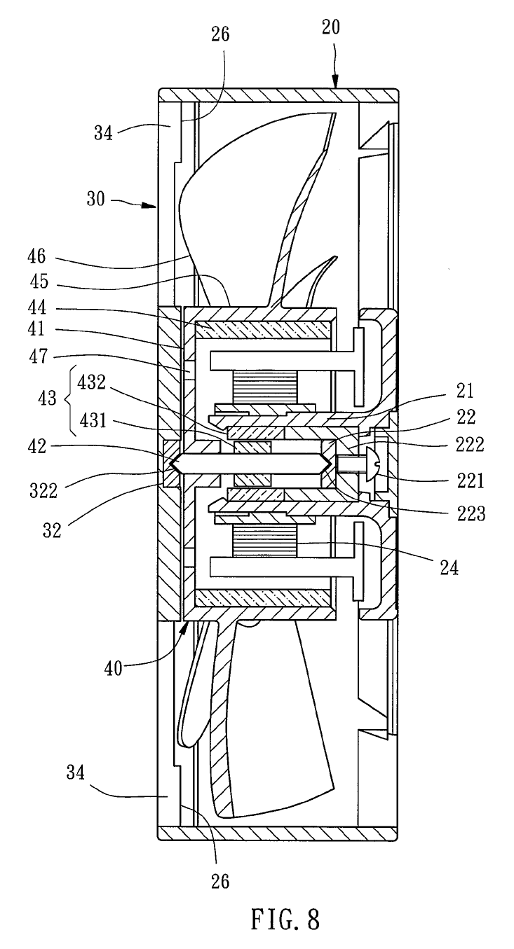

Referring to FIG. 8, when the magnetic floating shaft set 50 is used in a cooling fan, a magnetic floating bearing 43 may be set between the shaft 42 and the winding 24. The magnetic floating bearing 43 has an inner race 431 and an outer race 432. The inner race 431 is sleeved onto the shaft 42. The outer race 432 is set in the center portion 21 of the first rack 20 and kept spaced around the inner race 431. The magnetic floating bearing 43 imparts a magnetic force to the shaft 42 so that the shaft 42 can only be moved axially during its rotation, preventing biasing and assuring smooth and stable rotation.

In addition to the arrangement of the guides with the associated grooves to correct biasing of the shaft, the guides can be made to have a different design to fit the shaft.

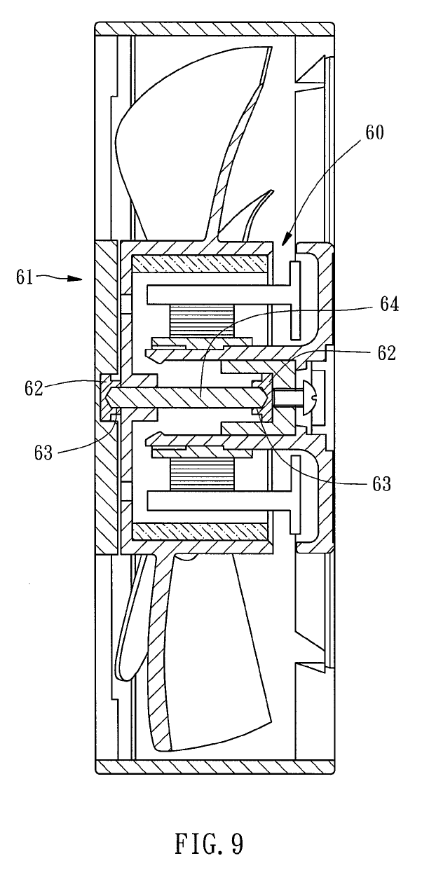

FIG. 9 shows a magnetic floating shaft set 60 used in a cooling fan 61 in accordance with a second embodiment of the present invention. This second embodiment is substantially similar to the aforesaid first embodiment, with the exception that each guide 62 has an annular flange 63 protruded from the surface thereof and defining therein a space. The shaft 64 has its two ends respectively inserted into the annular flanges 63 of the guides 62, i.e. the annular flanges 63 of the guides 62 surround the ends of the shaft 64.

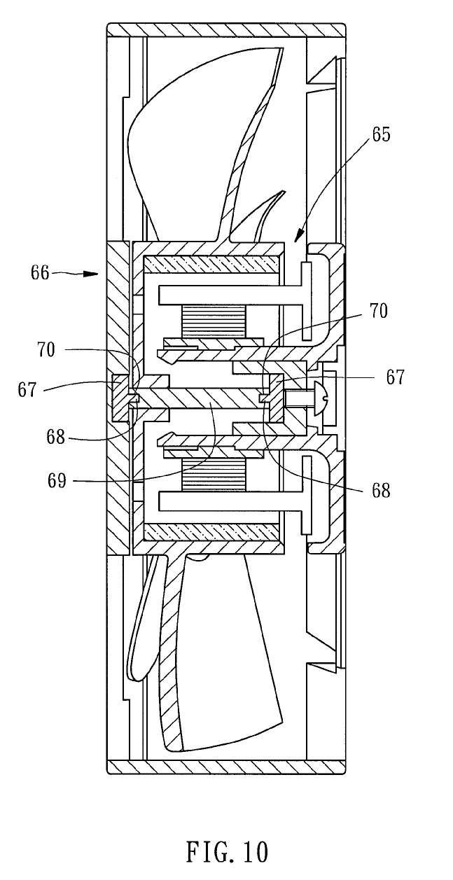

FIG. 10 shows magnetic floating shaft set 65 used in a cooling fan 66 in accordance with a third embodiment of the present invention. This third embodiment is substantially similar to the aforesaid first embodiment, with the exception that each guide 67 has a projecting rod 68; the shaft 69 has a recessed portion 70 disposed on each of the two ends thereof and respectively facing the projecting rods 68 of the two guides 67.

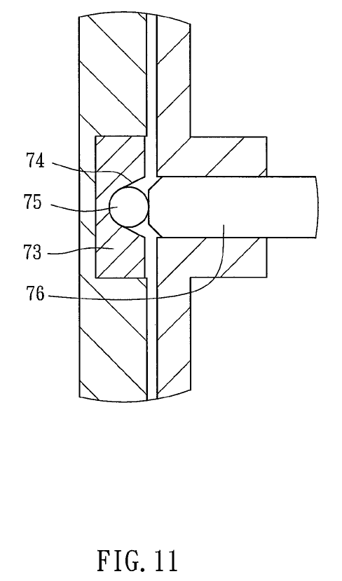

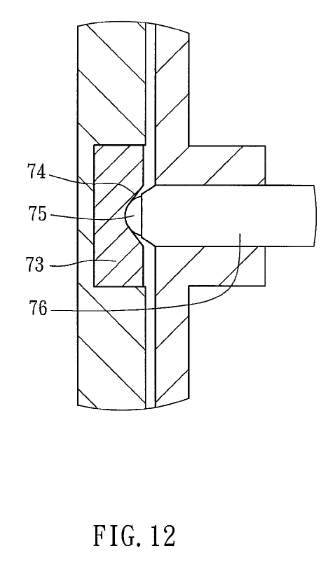

FIG. 11 shows magnetic floating shaft set 71 used in a cooling fan 72 in accordance with a fourth embodiment of the present invention. This fourth embodiment is substantially similar to the aforesaid first embodiment, with the exception that each guide 73 has a groove 74 and a ball 75 rotatably received in the groove 74. The two ends of the shaft 76 are respectively aimed at the guides 73 such that the balls 75 may touch the ends of the shaft 76 during movement of the shaft 76. Further, FIG. 12 shows the ball 75 set into one of the end of the shaft 76. The guides 73 of this fourth embodiment can also accurately guide and correct movement of the shaft 76.

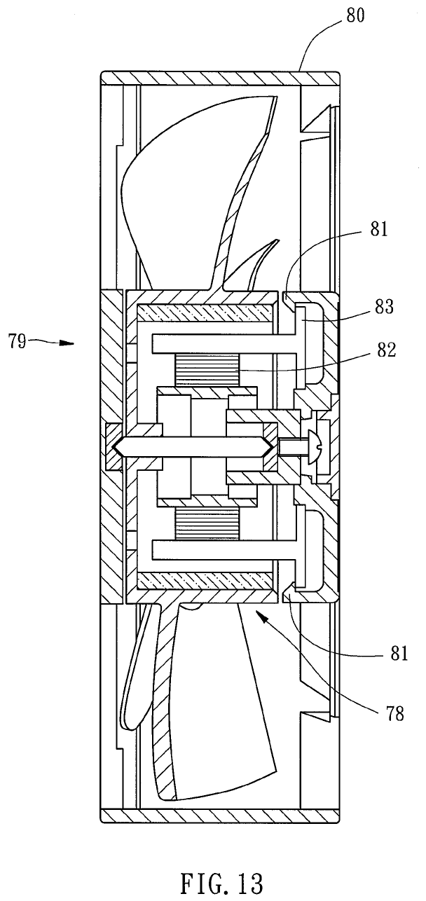

FIG. 13 shows a magnetic floating shaft set 78 used in a cooling fan 79 in accordance with a fifth embodiment of the present invention. This fifth embodiment is substantially similar to the aforesaid first embodiment, with the exception that the first rack 80 has a plurality of hooks 81; the circuit board 83 of the winding 82 of the magnetic floating shaft set 78 is fastened to the hooks 81. This fifth embodiment facilitates quick installation of the magnetic floating shaft set 78 in the first rack 80.

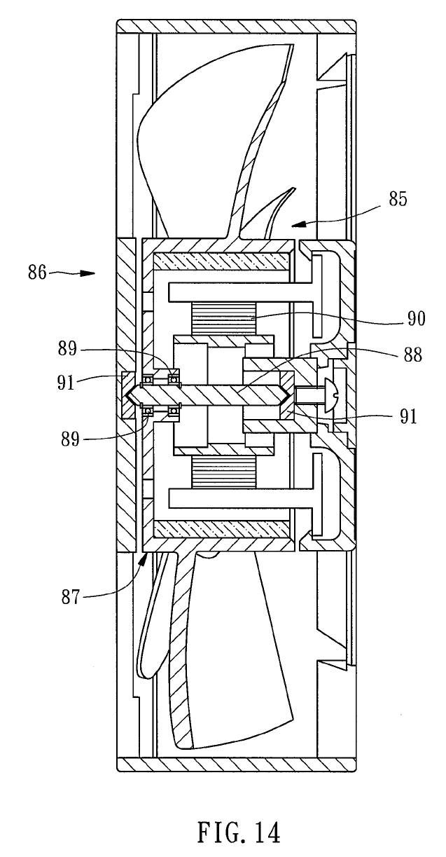

To accelerate the rotating speed of the magnetic floating shaft set and to lower its friction, a further sixth embodiment is provided. As shown in FIG. 14, a magnetic floating shaft set 85 is used in a cooling fan 86 in accordance with the sixth embodiment of the present invention. This sixth embodiment is substantially similar to the aforesaid first embodiment, with the exception that the magnetic floating shaft set 85 has two bearings 89 set between the actuator 87 and the shaft 88. When the induced magnetic force of the winding 90 drives the actuator 87 to rotate, the actuator 87 can be turned about the axis of the shaft 88, and the bearings 89 enable the rotating speed of the shaft 88 to be lower than the rotating speed of the actuator 87, thereby reducing possible friction and reaction force between the shaft 88 and two guides 91, accelerating the rotating speed of the actuator 87, and prolonging the working life of the present invention.

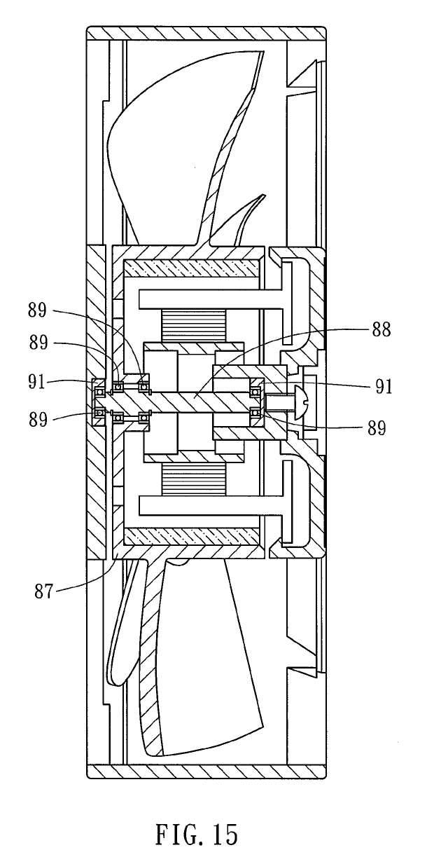

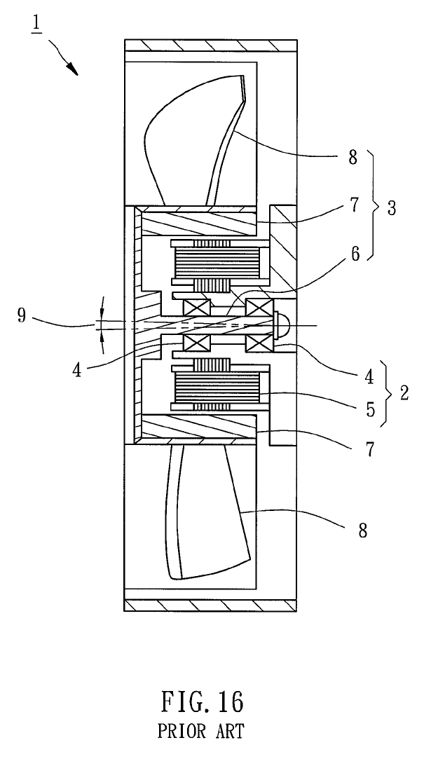

Referring to FIG. 15, bearings 89 may be provided between the shaft 89 and the actuator 87 and between the shaft 89 and the guides 91, achieving the aforesaid effect of accelerating the rotating speed.

A prototype of magnetic floating shaft set and apparatus using same has been constructed with the features of FIGS. 1˜15. The magnetic floating shaft set and apparatus using same functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims

What is claimed is:

1. A magnetic floating shaft set comprising:
two guides kept apart from each other at a distance, one of said two guides being movable relative to the other of said two guides to change the distance between said two guides;
a shaft set in between said two guides, said shaft having two distal ends respectively facing said two guides;
a magnetic member mounted around said shaft; and
a winding coaxially mounted around said shaft and adapted to generate a magnetic field to induce said magnetic member and to further cause floating of said shaft between said two guides and rotation of said magnetic member with said shaft.

2. The magnetic floating shaft set as claimed in claim 1, wherein at least one of said two guides has an annular flange protruded from a surface thereof, said annular flange defining therein a space for receiving the corresponding distal end of said shaft.

3. The magnetic floating shaft set as claimed in claim 1, wherein at least one of said two guides has a projecting rod facing the corresponding distal end of said shaft; and said shaft has a recessed portion at the corresponding distal end for receiving the projecting rod.

4. The magnetic floating shaft set as claimed in claim 1, wherein at least one of said two guides has a ball facing the corresponding distal end of said shaft.

5. The magnetic floating shaft set as claimed in claim 1, wherein the distance between said two guides is greater than the length of said shaft.

6. The magnetic floating shaft set as claimed in claim 1, further comprising a magnetic floating bearing mounted between said shaft and said winding.

7. The magnetic floating shaft set as claimed in claim 1, wherein said shaft has mounted thereon an actuator that holds said magnetic member.

8. The magnetic floating shaft set as claimed in claim 7, wherein said actuator comprises a base having a plurality of through holes, a sidewall perpendicularly extending along the periphery of said base, and a plurality of blades fastened to an outer side of said sidewall in a radial manner relative to said shaft; wherein said shaft is mounted in said base to have one of the two distal ends thereof extending out of said base and the other of the two distal ends thereof extending to inside of said sidewall, and said magnetic member is mounted in an inner side of said sidewall.

9. The magnetic floating shaft set as claimed in claim 1, further comprising at least one bearing set between said magnetic member and said shaft.

10. The magnetic floating shaft set as claimed in claim 1, wherein the centerline of the magnetic field of said magnetic member is in alignment with the centerline of the magnetic field of said winding such that said shaft is floating between said two guides.

11. A cooling fan comprising a first rack, a second rack, and a magnetic floating shaft set of claim 1, which is mounted between said first rack and said second rack, the two guides of said magnetic floating shaft set being respectively mounted in said first rack and said second rack.

12. The cooling fan as claimed in claim 11, wherein said first rack comprises a positioning member and an adjustment member; the guide of said magnetic floating shaft set mounted in said first rack is placed in said positioning member of said first rack; and said adjustment member is movably mounted in said positioning member and coupled to the guide of said magnetic floating shaft set mounted in said first rack.

13. A magnetic floating shaft set comprising:
two guides kept apart from each other at a distance;
a shaft set in between said two guides, said shaft having two distal ends respectively facing said two guides;
at least one bearing mounted on said shaft;
an actuator mounted on said at least one bearing;
a magnetic member mounted on said actuator; and
a winding coaxially mounted around said shaft and adapted to generate a magnetic field to induce said magnetic member and to further cause floating of said shaft between said two guides and rotation of said magnetic member on said shaft.

14. The magnetic floating shaft set as claimed in claim 13, wherein at least one of said two guides has an annular flange protruded from a surface thereof, said annular flange defining therein a space for receiving the corresponding distal end of said shaft.

15. The magnetic floating shaft set as claimed in claim 13, wherein at least one of said two guides has a projecting rod facing the corresponding distal end of said shaft; and said shaft has a recessed portion at the corresponding distal end for receiving the projecting rod.

16. The magnetic floating shaft set as claimed in claim 13, wherein the distance between said two guides is greater than the length of said shaft.

17. The magnetic floating shaft set as claimed in claim 13, wherein said actuator comprises a base having a plurality of through holes, a sidewall perpendicularly extending along the periphery of said base, and a plurality of blades affixed to an outer side of said sidewall in a radial manner relative to said shaft; wherein said shaft is mounted in said base to have one of the two distal ends thereof extending out of said base and the other of the two distal ends thereof extending to inside of said sidewall, and said magnetic member is mounted in an inner side of said sidewall.

18. The magnetic floating shaft set as claimed in claim 13, wherein the centerline of the magnetic field of said magnetic member is in alignment with the centerline of the magnetic field of said winding such that said shaft is floating between said two guides.

19. The magnetic floating shaft set as claimed in claim 13, further comprising a positioning member holding one of said two guides, and an adjustment member movably mounted in said positioning member and coupled to the guide held by said positioning member.
